(19) United States
(12) Patent Application Publication
(10) Pub. No.: US 2002/0176394 A1
(43) Pub. Date: Nov. 28, 2002

(54) Coupling of a mobile testing system

(76) Inventors: Boaz E. Bryger, Zikhron-Ya'aqov (IL); Haggai Heller, Haifa (IL); Yoram Rimoni, Haifa (IL)

Correspondence Address: QUALCOMM Incorporated, Attn: Patent Department, 5775 Morehouse Drive, San Diego, CA, 92121-1714, US

(21) Appl. No.: 10/118,866

(22) Filed: Apr. 8, 2002

Related U.S. Application Data
(60) Provisional application No. 60/282,690, filed on Apr. 9, 2001.

(51) Int. Cl. H04B 7/216

(52) U.S. Cl. 370/342; 370/441; 370/347

(57) ABSTRACT

Testing apparatus, including a base station transceiver (BTS) simulator, which is adapted to simulate signals transmitted by a BTS and to process signals that are ordinarily received by the BTS. The apparatus also includes a channel simulation unit, which is adapted to provide a communication channel for the simulated signals and to communicate with a mobile cellular telephone, and a coupling connecting the BTS simulator and the channel simulation unit, enabling the BTS simulator and channel simulation unit to communicate digitally.

### CROSS-REFERENCE TO RELATED APPLICATIONS

This application is related to a U.S. patent application entitled “Mobile System Testing Architecture,” Attorney Docket Number 000083, filed on even date, and to U.S. patent application entitled “Mobile System Testing Architecture”, Attorney Docket Number 000082, which are assigned to the assignee of the present invention and whose disclosures are incorporated herein by reference.

### FIELD OF THE INVENTION

The present invention relates generally to telephone testing systems, and specifically to mobile cellular telephone testing systems.

### BACKGROUND OF THE INVENTION

Mobile cellular telephones, herein below termed mobiles, are required to operate under extremely demanding conditions with respect to the signals they are required to receive. Effects such as large, and varying, signal attenuation from a base station transceiver (BTS), together with noise effects such as Rayleigh fading, Ricean fading, impulse noise, cyclostationary noise, and intersymbol noise, contribute to the difficult conditions. Mobiles are tested by simulating these conditions.

FIG. 1 is a schematic illustration of a system 10 for testing mobiles, as is known in the art. A BTS 14 communicates via a first radio-frequency (RF) link 11 with a channel simulation unit 16, which in turn communicates via a second RF link 13 with a mobile 18. Alternatively, BTS 14 is replaced by a BTS emulator. Channel simulation unit 16 introduces effects such as those described above in order to simulate signals which are received by mobile 18 when it is being used in typical field operating situations. Optionally, a separate noise generator 15 is also incorporated in line 13 to introduce some of the required noise effects.

The PropSim Radio Channel Simulator system, produced by Elektrobit Ltd., of Oulu, Finland, is a channel simulation unit comprising hardware and software which is able to simulate effects such as those described above over up to two radio channels. The system requires a nominal radio-frequency (RF) input level of −15 dBm.

Telecom Analysis Systems of Eatontown, New Jersey, produce the TAS 4500 FLEX5 channel simulation unit, which is also able to simulate a range of effects over a radio channel and which requires an RF input.

As noted above, mobile testing systems such as those described hereinabove operate on an RF interface between the BTS or BTS emulator and the channel simulation unit. However, systems comprising a BTS or a BTS emulator with an RF interface to a channel simulator are limited in accuracy of settings of test parameters, because of inherent limitations associated with the RF interface.

### SUMMARY OF THE INVENTION

It is an object of some aspects of the present invention to provide a mobile testing system wherein test parameters can be accurately set.

It is a further object of some aspects of the present invention to provide a testing system wherein testing signals are fully controllable by an operator of the system.

In preferred embodiments of the present invention, operations of a base station transceiver (BTS) are implemented in a BTS simulator. The BTS simulator is connected by a digital coupling to a channel simulation unit, so that the BTS simulator and channel simulation unit are able to communicate with each other under full control of an operator of the system. The operator utilizes the channel simulation unit to digitally modify one or more forward channels conveying digital forward signals from the BTS simulator, so as to accurately simulate effects such as noise and/or attenuation in the transmission from the BTS being simulated. The channel simulation unit converts the modified signals from the BTS simulator into corresponding radio-frequency (RF) signals which are transmitted to a mobile.

Similarly, on a reverse path, the channel simulation unit receives RF signals from the mobile in one or more reverse channels (independent of the forward channels) and modifies the signals before transferring the reverse signals via the digital coupling to the BTS simulator. The combination of the BTS simulator connected by the digital coupling to the channel simulation unit forms a mobile testing system. Implementing the mobile testing system by digitally coupling the BTS simulator to the channel simulator significantly improves the accuracy and versatility of tests on mobiles, compared to systems known in the art.

There is therefore provided, according to a preferred embodiment of the present invention, testing apparatus, including:

a base station transceiver (BTS) simulator, which is adapted to simulate signals transmitted by a BTS and to process signals that are ordinarily received by the BTS;

a channel simulation unit, which is adapted to provide a communication channel for the simulated signals and to communicate with a mobile cellular telephone; and

a coupling connecting the BTS simulator and the channel simulation unit, enabling the BTS simulator and channel simulation unit to communicate digitally.

Preferably, the signals simulated by the BTS simulator include signals compatible with a Code Division Multiple Access (CDMA) protocol.

Alternatively, the signals simulated by the BTS simulator include signals compatible with a Time Division Multiple Access (TDMA) protocol.

Preferably, the communication channel provided by the channel simulation unit includes a plurality of forward channels and a plurality of reverse channels.

Preferably, the channel simulation unit includes a noise unit which generates digital noise in the communication channel.

Further preferably, the coupling includes a digital bus having separate lines for conveying reverse and forward signals between the BTS simulator and the channel simulation unit.

Preferably, the coupling includes one or more media selected from a group comprising coaxial cable, fiber-optic cable, transmission line, and conducting wire.

There is further provided, according to a preferred embodiment of the present invention, a method for testing a mobile cellular telephone, including:

simulating operations of a base station transceiver (BTS) using a BTS simulator;

simulating a communication channel between the BTS simulator and the mobile cellular telephone using a channel simulation unit; and

coupling the BTS simulator and the channel simulation unit so as to enable the BTS simulator and channel simulator to communicate digitally.

Preferably, simulating operations of the BTS includes simulating signals compatible with a Code Division Multiple Access (CDMA) protocol.

Alternatively, simulating operations of the BTS includes simulating signals compatible with a Time Division Multiple Access (TDMA) protocol.

Preferably, simulating the communication channel includes simulating a plurality of forward channels and a plurality of reverse channels.

Preferably, the channel simulation unit includes a noise unit, and simulating the communication channel includes generating digital noise in the communication channel with the noise unit.

Preferably, coupling the BTS simulator and the channel simulation unit includes coupling the BTS simulator and the channel simulation unit by a digital bus having separate lines for conveying reverse and forward signals between the BTS simulator and the channel simulation unit.

Further preferably, coupling the BTS simulator and the channel simulation unit includes coupling the BTS simulator and the channel simulation unit by one or more media selected from a group comprising coaxial cable, fiber-optic cable, transmission line, and conducting wire.

The present invention will be more fully understood from the following detailed description of the preferred embodiments thereof, taken together with the drawings, in which:

### BRIEF DESCRIPTION OF THE DRAWINGS

FIG. 1 is a schematic illustration of a system for testing mobiles, as is known in the art; and

FIG. 2 is a schematic block diagram of a mobile testing system, according to a preferred embodiment of the present invention.

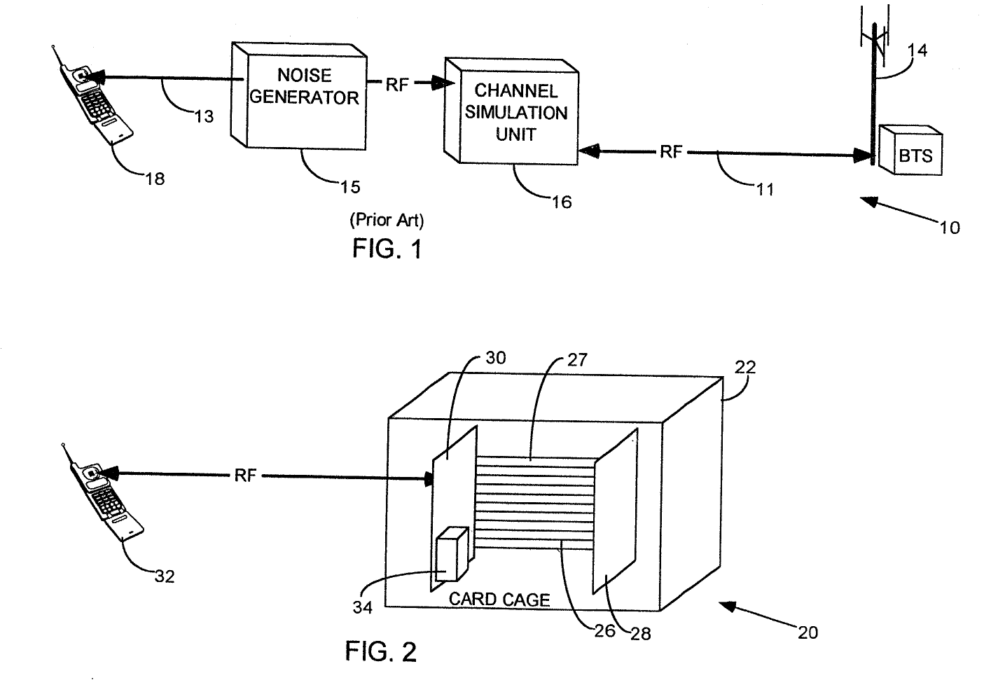

### DETAILED DESCRIPTION OF PREFERRED EMBODIMENTS

Reference is now made to FIG. 2, which is a schematic block diagram of a mobile testing system 20, according to a preferred embodiment of the present invention. A base station simulator 28 simulates operation of a base station controller (BSC) controlling one or more base station transceivers (BTSs). A suitable base station simulator and its operation is described in a U.S. patent application entitled “Mobile System Testing Architecture,” filed on even date with the present application, which is assigned to the assignee of the present invention. Simulator 28 generates forward and reverse signals which would be produced by the one or more BTSs when operating in a cellular telephone network. Preferably, the network operates under a Code Division Multiple Access (CDMA) protocol known in the art. Alternatively, the network operates under any other standard cellular telephone network protocol, such as a Time Division Multiple Access (TDMA) protocol.

In order to simulate effects on transmissions, such as those effects described in the Background of the Invention, forward signals from simulator 28 are transferred to a channel simulation unit 30, wherein the effects are simulated in one or more forward channels whose characteristics are controlled by an operator of system 20. A suitable channel simulation unit is described in the patent application entitled “Mobile System Testing Architecture,” and also in a patent application Ser. No. ______ Attorney Docket Number 000082, which is assigned to the assignee of the present invention. Channel simulation unit 30 also simulates one or more reverse channels whose characteristics are also controlled by an operator of system 20.

Simulation unit 30 further comprises a noise unit 34, wherein noise levels are set digitally, by modifying the existing digital signals in unit 30. It will be appreciated that introducing controlled digital noise into existing digital signals is significantly simpler compared to the introduction of analog noise into analog signals. It will also be appreciated that setting noise levels digitally significantly increases the accuracy with which noise is introduced into the system, and so enhances the accuracy of signal-to-noise measurements made by the system.

Most preferably, simulator 28 and channel simulation unit 30 are each implemented as one or more cards connected by a coupling 27 capable of conveying digital signals, such as a bus 26 in a card-cage 22. When coupling 27 comprises bus 26, digital signals between simulator 28 and unit 30 are transferred via the bus. Preferably, bus 26 comprises separate lines for transferring forward signals from simulator 28 to unit 30, and for transferring reverse signals from unit 30 to simulator 28, as well as clock and control signals.

Alternatively, coupling 27 comprises other means known in the art, such as one or more media selected from a group comprising coaxial cable, fiber-optic cable, transmission line, and conducting wire, which are able to convey forward and reverse digital signals between simulator 28 and unit 30. It will be appreciated that signals transferred between simulator 28 and unit 30 which are initially in a non-digital form can be converted into a digital form suitable for transmission on coupling 27, and then reconverted into their initial form. For example, if coupling 27 comprises bus 26, forward analog signals from simulator 28 may be converted via an analog-digital converter in the simulator to digital signals, the digital signals are then placed on bus 26, and the digital signals are reconverted to the original analog signals by a digital-analog converter in unit 30. A similar process applies for transferring reverse signals from unit 30 to simulator 28.

After introducing the desired effects into the forward signals received from coupling 27, channel simulation unit 30 converts the signals to electromagnetic radiation signals at a frequency receivable by a mobile 32, and conveys the converted signals to the mobile. Similarly, for reverse signals from mobile 32, unit 30 introduces desired effects into the one or more reverse channels conveying the reverse signals, and transfers the modified signals on coupling 27 to simulator 28.

It will be appreciated that using a digital coupling between simulator 28 and channel simulation unit 30 substantially increases the accuracy of test parameters set in system 20.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Testing apparatus, comprising:
a base station transceiver (BTS) simulator, which is adapted to simulate signals transmitted by a BTS and to process signals that are ordinarily received by the Bts;
a channel simulation unit, which is adapted to provide a communication channel for the simulated signals and to communicate with a mobile cellular telephone; and
a coupling connecting the bts simulator and the channel simulation unit, enabling the bts simulator and channel simulation unit to communicate digitally.

2. Testing apparatus according to claim 1, wherein the signals simulated by the BTS simulator comprise signals compatible with a Code Division Multiple Access (CDMA) protocol.

3. Testing apparatus according to claim 1, wherein the signals simulated by the BTS simulator comprise signals compatible with a Time Division Multiple Access (TDMA) protocol.

4. Testing apparatus according to claim 1, wherein the communication channel provided by the channel simulation unit comprises a plurality of forward channels and a plurality of reverse channels.

5. Testing apparatus according to claim 1, wherein the channel simulation unit comprises a noise unit which generates digital noise in the communication channel.

6. Testing apparatus according to claim 1, wherein the coupling comprises a digital bus having separate lines for conveying reverse and forward signals between the BTS simulator and the channel simulation unit.

7. Testing apparatus according to claim 1, wherein the coupling comprises one or more media selected from a group comprising coaxial cable, fiber-optic cable, transmission line, and conducting wire.

8. A method for testing a mobile cellular telephone, comprising:
simulating operations of a base station transceiver (BTS) using a BTS simulator;
simulating a communication channel between the BTS simulator and the mobile cellular telephone using a channel simulation unit; and
coupling the BTS simulator and the channel simulation unit so as to enable the BTS simulator and channel simulator to communicate digitally.

9. A method according to claim 8, wherein simulating operations of the BTS comprises simulating signals compatible with a Code Division Multiple Access (CDMA) protocol.

10. A method according to claim 8, wherein simulating operations of the BTS comprises simulating signals compatible with a Time Division Multiple Access (TDMA) protocol.

11. A method according to claim 8, wherein simulating the communication channel comprises simulating a plurality of forward channels and a plurality of reverse channels.

12. A method according to claim 8, wherein the channel simulation unit comprises a noise unit, and wherein simulating the communication channel comprises generating digital noise in the communication channel with the noise unit.

13. A method according to claim 8, wherein coupling the BTS simulator and the channel simulation unit comprises coupling the BTS simulator and the channel simulation unit by a digital bus having separate lines for conveying reverse and forward signals between the BTS simulator and the channel simulation unit.

14. A method according to claim 8, wherein coupling the BTS simulator and the channel simulation unit comprises coupling the BTS simulator and the channel simulation unit by one or more media selected from a group comprising coaxial cable, fiber-optic cable, transmission line, and conducting wire.
